(19) United States
(12) Patent Application Publication
(10) Pub. No.: US 2020/0406275 A1
(43) Pub. Date: Dec. 31, 2020

(54) ENERGY-SAVING SHOWER HAVING USER-FRIENDLY DEVICE

(71) Applicant: Xiamen Easo Co., Ltd, Xiamen (CN)

(72) Inventors: Xiaoming Fujian Tu, Xiamen Fujian (CN); Haitao Lu, Xiaoming Fujian (CN); Yuebin Yang, Xiaoming Fujian (CN); Ximin Chen, Xiaoming Fujian (CN)

(73) Assignee: Xiamen Easo Co., Ltd, Xiamen (CN)

(21) Appl. No.: 16/882,516

(22) Filed: May 24, 2020

(30) Foreign Application Priority Data
Jun. 28, 2019 (CN) 201910575739.8

(51) Int. Cl. B05B 1/18; B05B 1/16

(52) U.S. Cl. CPC B05B 1/185; B05B 1/16

(57) ABSTRACT

An energy-saving shower having a user-friendly device includes a top spray module, an upper shower rod, and a lower shower rod, wherein a shoulder spray module is arranged between the upper shower rod and the lower shower rod. A shoulder spray of the shower prevents the hair of a user from getting wet during a shower, and exactly sprays water to shoulders to relieve shoulder pains, so that the user will feel comfortable during the shower, and the shower experience is improved.

### BACKGROUND OF THE INVENTION

### 1. Technical Field

The invention relates to an energy-saving shower having a user-friendly device.

### 2. Description of Related Art

Existing showers are provided with a shower nozzle and a top spray. When users turn on the top spray to take a shower, the hair is inevitably wet, which greatly reduces the shower experience of female users who usually bathe and wash their hair separately. With the economic boom, more and more office workers are suffering from shoulder pains due to long-term sitting or working. Shower products on the market cannot effectively solve this problem for consumers. Thus, this solution upgrades such showers to improve the shower experience of the users to make sure that the users feel more comfortable during the shower.

### BRIEF SUMMARY OF THE INVENTION

The objective of the invention is to solve the above technical problem by providing an energy-saving shower having a user-friendly device.

The invention is achieved through the following technical solution: an energy-saving shower having a user-friendly device comprises a top spray module, an upper shower rod, and a lower shower rod, wherein a shoulder spray module is arranged between the upper shower rod and the lower shower rod.

Preferably, the shower having a user-friendly device further comprises a faucet module used for controlling the upper water outflow and the lower water outflow of the shower having a user-friendly device and a water outlet pipe module.

Preferably, the water outlet pipe module includes a water outlet pipe, and when the shower having a user-friendly device performs the lower water outflow, the lower water outlet pipe module controls the water outlet pipe or a shower nozzle module to spray water from below.

Preferably, when the shower having a user-friendly device performs the upper water outflow, a water flow reaches the shoulder spray module and is then controlled by the shoulder spray module to flow out from above via the shoulder spray module or the top spray module.

Preferably, the shower having a user-friendly device further comprises a control module used for controlling the upper water inflow and the lower water inflow of the shower having a user-friendly device and the water outlet pipe module.

Preferably, when the shower having a user-friendly device performs the upper water inflow, a water flow inflowing from above reaches the shoulder spray module and is then controlled by the shoulder spray module to flow out from above via the shoulder spray module or the top spray module.

Preferably, when the shower having user-friendly device performs the lower water inflow, a water flow inflowing from below flows to the faucet module or the shower nozzle module via the water outlet pipe in the lower water outlet pipe module to flow out from below.

Preferably, the control module is connected with a water inlet pipe embedded into a wall.

Preferably, the upper shower rod and the lower shower rod are respectively arranged outside and inside the wall.

Preferably, the control module includes a switch control valve and a water outlet pipe.

The invention has the following beneficial effects: a shoulder spray of the shower prevents the hair of a user from getting wet during a shower, exactly sprays water to shoulders to relieve shoulder pains, so that the user will feel comfortable during the shower, and the shower experience is improved.

### BRIEF DESCRIPTION OF THE SEVERAL VIEWS OF THE DRAWINGS

For the sake of a clearer explanation of the technical solutions of the invention, a brief description of the accompanying drawings required by embodiments is given below. Clearly, the accompanying drawings in the following description are only used for illustrating certain embodiments of the invention, and those ordinarily skilled in the art can acquire other accompanying drawings according to the following ones without creative labor.

FIG. 1 is perspective exploded view of Embodiment 1 of the invention;

FIG. 2 is perspective view of Embodiment 1 of the invention;

FIG. 3 is side view of Embodiment 1 of the invention;

FIG. 4 is rear view of Embodiment 1 of the invention;

FIG. 5 is perspective exploded view of Embodiment 2 of the invention;

FIG. 6 is side view of Embodiment 2 of the invention;

FIG. 7 is perspective view of Embodiment 2 of the invention;

FIG. 8 is perspective exploded view of Embodiment 3 of the invention;

FIG. 9 is side view of Embodiment 3 of the invention;

FIG. 10 is rear view of Embodiment 3 of the invention;

Reference Signs: 1, top spray module; 2, upper shower rod; 3, shoulder spray; 4, lower shower rod; 5, shower nozzle module; 6, faucet module; 7, water outlet pipe module; 8, wall: 9, control module; 10, shunt valve; 11, switch control valve; 12. water outlet pipe.

### DETAILED DESCRIPTION OF THE INVENTION ()

The technical solutions of the embodiments of the invention are clearly and completely described below in combination with the accompanying drawings. Clearly, the embodiments in the following description are only illustrative ones, and are not all possible ones of the invention. All other embodiments obtained by those ordinarily skilled in the art on the basis of these illustrative embodiments without creative labor should also fall within the protection scope of the invention.

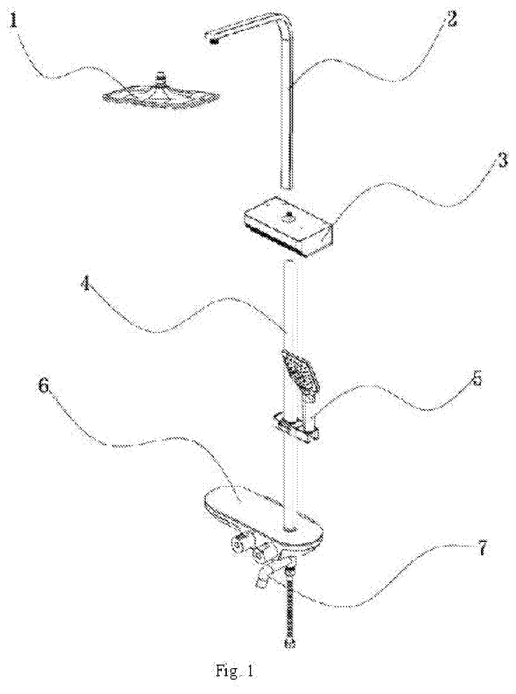

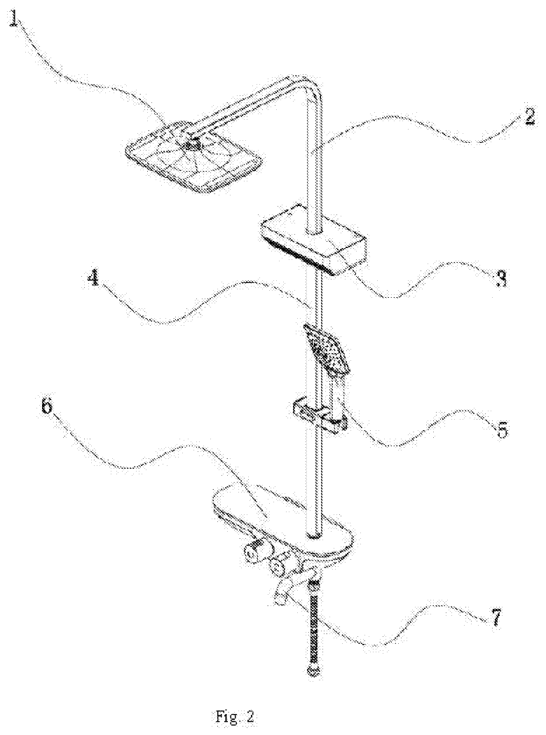

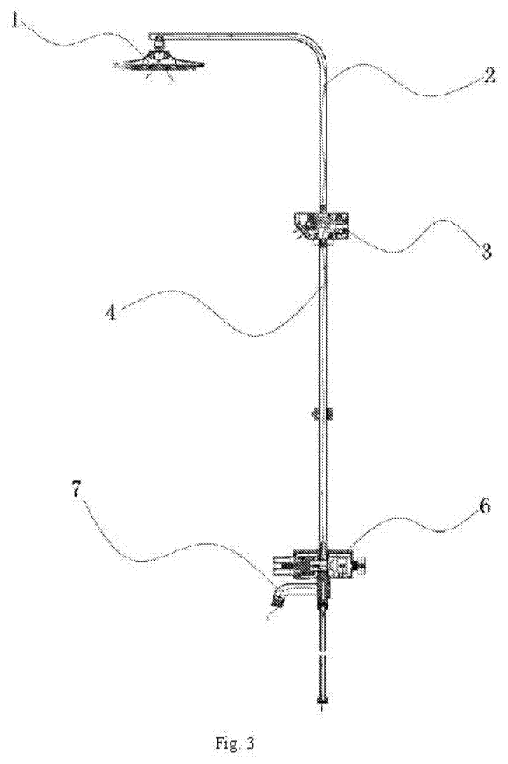

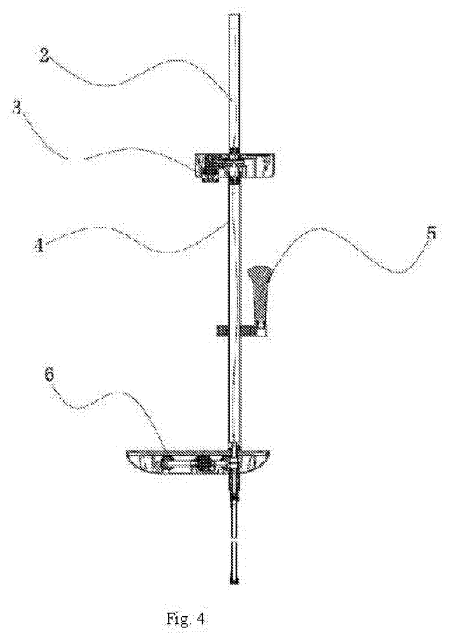

FIG. 1 to FIG. 4 show Embodiment 1 of the invention. An energy-saving shower having a user-friendly device comprises a top spray module, an upper shower rod, and a lower shower rod, wherein a shoulder spray module is arranged between the upper shower rod and the lower shower rod. The shower having a user-friendly device fulfills the inflow and outflow of hot and cold water.

As shown in FIG. 1, the shower having a user-friendly device further comprises a shower nozzle module, a faucet module. and a water outlet pipe module, wherein the faucet module is used for controlling the upper water outflow and the lower water outflow of the shower having a user-friendly device, and has an upper end connected with the lower shower rod as well as a lower end connected with the water outlet pipe module and the shower nozzle module, and two switch devices are arranged on the faucet module to respectively control the upper water outflow and the lower water outflow of the shower having a user-friendly device.

The water outlet pipe module includes a water outlet pipe. When the faucet module is set to perform the lower water outflow, the lower water outlet pipe module controls the water outlet pipe or a shower nozzle module to spray water from below; and when the faucet module is set to perform the upper water outflow, a water flow reaches the shoulder spray module via the lower shower rod and is then controlled by the shoulder spray module to flow out from above via the shoulder spray module, or reaches the top spray module via the upper shower rod to flow out from above. As shown in FIG. 1, a shoulder spray is internally provided with a shunt value used for distributing water to a top spray according to the setting, and has an oblique surface inclining by an angle, water outlets are uniformly distributed in the oblique surface, and the inclination angle of the oblique surface is adapted to human shoulders, that is, the shoulder spray module exactly sprays water to human shoulders.

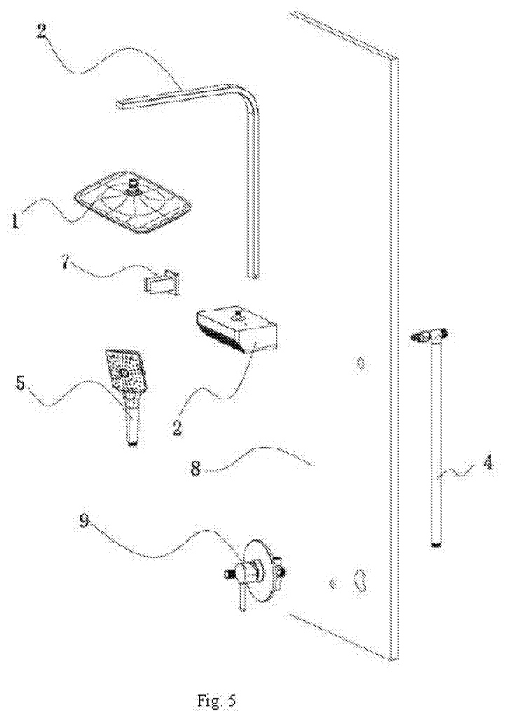

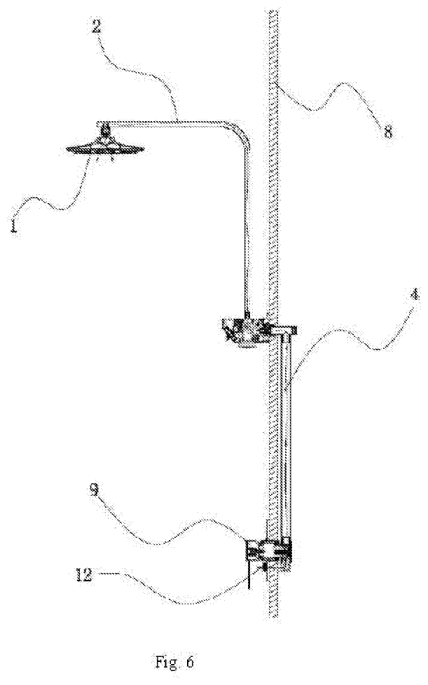

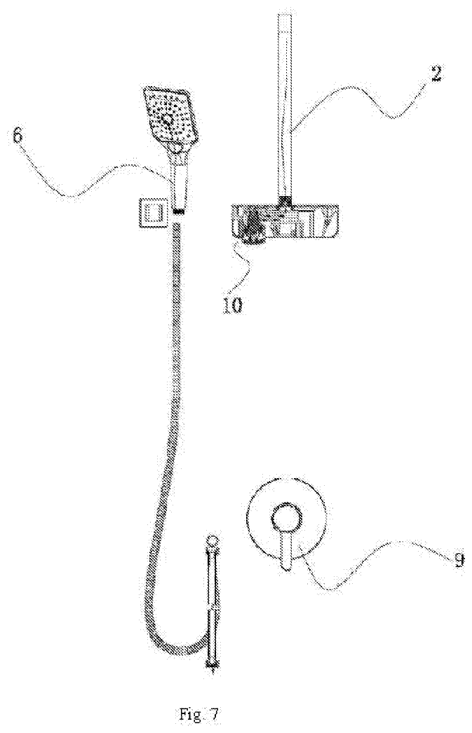

FIG. 5 to FIG. 7 show Embodiment 2 of the invention. The shower having a user-friendly device further comprises a control module, a shower nozzle module, a faucet module, and a water outlet pipe module, wherein the control module is connected with a water inlet pipe embedded into a wall, the lower shower rod located in the wall, and a water outlet pipe, and is used for controlling the upper water inflow and the lower water inflow of the shower having a user-friendly device. When the control module is set to perform the upper water inflow, a water flow reaches the shoulder spray module via the lower shower rod and is then controlled by the shoulder spray module to flow out from above via the shoulder spray module, or reaches the top spray via the upper shower rod located outside the wall to flow out from above; and when the control module is set to perform the lower water inflow, a water flow inflowing from below flows to the faucet module or the shower nozzle module via the water outlet pipe in the lower water outlet pipe module to flow out from below. The control module is provided with a handle which is rotated to control water to enter the water inlet pipe from above or from below.

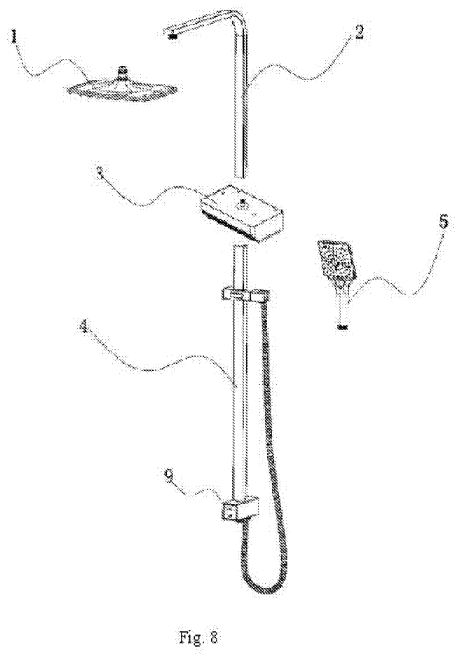

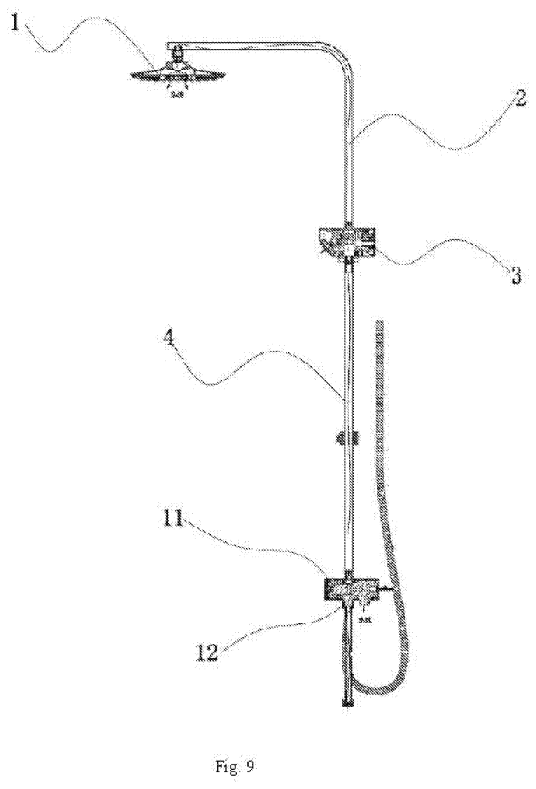

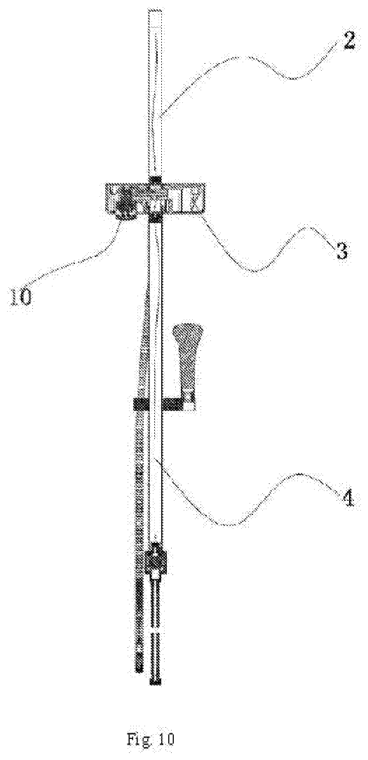

FIG. 8 to FIG. 10 show Embodiment 3 of the invention. The shower having a user-friendly device further comprises a control module, a shower nozzle module, a faucet module, and a water outlet pipe module, wherein the control module is connected with a water inlet pipe, the lower shower rod, and the water outlet pipe and is used for controlling the upper water inflow and the lower water inflow of the shower having a user-friendly device. When the control module is set to perform the upper water inflow, the water flow reaches the shoulder spray module via the lower shower rod and is controlled by the shoulder spray module to flow out from above via the shoulder spray module, or reaches the top spray via the upper shower rod located outside the wall to flow out from above; and when the control module is set to perform the lower water inflow, the water flow inflowing from below flows to the faucet module or the shower nozzle module via the water outlet pipe in the lower water outlet pipe module to flow out from below. The upper shower rod and the lower shower rod are located outside the wall, the control module is rectangular and is internal provided with a switch control valve and a corresponding control circuit to control the upper water outflow and the lower water outflow according to changes of external parameters such as sounds, gestures, and the like.

The above embodiments are preferred ones of the invention. As previously mentioned, it should be understood that the invention is not limited to the form disclosed herein, should not be regarded as an exclusion of other embodiments, and is suitable for various combinations, modifications and environments, and can be changed within the scope of the conception, described herein, of the invention on the basis of the above teachings, or technologies or knowledge in the related field. These changes and transformations made by those skilled in the art should also fall within the protection scope of the appended claims of the invention without deviating from the spirit and scope of the invention.

What is claimed is:

1. An energy-saving shower having a user-friendly device, comprising a top spray module, an upper shower rod, and a lower shower rod, wherein a shoulder spray module is arranged between the upper shower rod, and the lower shower rod.

2. The shower having a user-friendly device according to claim 1, wherein the shower having a user-friendly device further comprises a faucet module used for controlling an upper water outflow and a lower water outflow of the shower having a user-friendly device, and a water outlet pipe module.

3. The shower having a user-friendly device according to claim 2, wherein the water outlet pipe module includes a water outlet pipe and when the shower having a user-friendly device performs the lower water outflow, the lower water outlet pipe module controls the water outlet pipe or a shower nozzle module to spray water from below.

4. The shower having a user-friendly device according to claim 2, wherein when the shower having a user-friendly device performs the upper water outflow, a water flow reaches the shoulder spray module and is then controlled by the shoulder spray module to flow out from above via the shoulder spray module or the top spray module.

5. The shower having a user-friendly device according to claim 1, wherein the shower having a user-friendly device further comprises a control module used for controlling an upper water inflow and a lower water inflow of the shower having a user-friendly device, and a water outlet pipe module.

6. The shower having a user-friendly device according to claim 5, wherein when the shower having a user-friendly device performs the upper water inflow, a water flow inflowing from above reaches the shoulder spray module and is then controlled by the shoulder spray module to flow out from above via the shoulder spray module or the top spray module.

7. The shower having a user-friendly device according to claim 5, wherein when the shower having a user-friendly device performs the lower water inflow, a water flow inflowing from below flows to a faucet module or a shower nozzle module via a water outlet pipe in the lower water outlet pipe module to flow out from below.

8. The shower having a user-friendly device according to any one claims 5-7, wherein the control module is connected with a water inlet pipe embedded into a wall.

9. The shower having a user-friendly device according to one of claims 5-7, wherein the upper shower rod and the lower shower rod are respectively arranged outside and inside a wall.

10. The shower having a user-friendly device according to any one of claims 5-7, wherein the control module includes a switch control valve and a water outlet pipe.
